(19) United States
(12) Patent Application Publication
(10) Pub. No.: US 2025/0112515 A1
(43) Pub. Date: Apr. 3, 2025

(54) STATOR FOR ROTATING ELECTRIC MACHINE, AND INSULATOR

(71) Applicants: KABUSHIKI KAISHA TOYOTA JIDOSHOKKI, Kariya-shi (JP); AICHI ELECTRIC CO., LTD., Kasugai-City (JP)

(72) Inventors: Shuji TAKIMOTO, Kariya-shi (JP); Keisuke ISOBE, Kariya-shi (JP); Takashi HORI, Kasugai-City (JP); Yudai SUZUKI, Kasugai-City (JP)

(73) Assignees: KABUSHIKI KAISHA TOYOTA JIDOSHOKKI, Kariya-shi (JP); AICHI ELECTRIC CO., LTD., Kasugai-City (JP)

(21) Appl. No.: 18/897,492

(22) Filed: Sep. 26, 2024

(30) Foreign Application Priority Data
Oct. 2, 2023 (JP) 2023-171328

(51) Int. Cl. H02K 3/52

(52) U.S. Cl. CPC H02K 3/38; H02K 3/522; H02K 2203/12

(57) ABSTRACT

A coil is formed by a winding wound in a concentrated manner over multiple layers around a tooth and an insulator extension. The insulator extension includes an outer end face located on a side opposite to a stator core. A first turn of the winding that forms a first layer of the coil includes a winding start portion that extends through a first innermost part along a first tooth side surface and a portion that is wound around an outer end face of the insulator extension. The outer end face includes a protrusion protruding from a portion of the outer end face that is closer to an insulator base than the first turn and relatively close to the winding start portion. The winding that forms a specific layer of the coil is extended through a second innermost part along a second tooth side surface and then arranged on the protrusion.

### CROSS-REFERENCE TO RELATED APPLICATIONS

This application is based upon and claims the benefit of priority from prior Japanese Patent Application No. 2023-171328, filed on Oct. 2, 2023, the entire contents of which are incorporated herein by reference.

### BACKGROUND

### 1. Field

The present disclosure relates to a stator for a rotating electric machine and an insulator.

### 2. Description of Related Art

Japanese Laid-Open Patent Publication No. 2006-115565 discloses an example of a stator for a rotating electric machine. The stator includes a stator core, coils, and an insulator. The stator core includes a tubular yoke and teeth. The teeth extend from the inner circumferential surface of the yoke toward the inner side in the radial direction. The stator core includes slots each located between adjacent ones of the teeth in the circumferential direction. Each coil is formed by a winding passing through the corresponding slot around the stator core. The insulator is located to face a core end face of the stator core, which is an end face of the yoke in the axial direction. The insulator isolates the coils from the core end face.

The teeth each include a first tooth side surface located on a first side in the circumferential direction and a second tooth side surface located on a second side in the circumferential direction. Further, the insulator includes a tubular insulator base and insulator extensions. The insulator base faces the yoke in the axial direction. The insulator extensions extend from the inner circumferential surface of the insulator base toward the inner side in the radial direction and respectively face the teeth in the axial direction. The coil is formed by the winding wound in a concentrated manner over multiple layers around the tooth and insulator extension, with the winding moving back and forth in the radial direction of the yoke. The winding extends helically in each layer of the coil.

The first layer of the coil may be formed by the winding wound from the outer side toward the inner side of the yoke in the radial direction. Of the portion of each slot that is proximate to the inner circumferential surface of the yoke, the portion proximate to the first tooth side surface is referred to as a first innermost part and the portion proximate to the second tooth side surface is referred to as a second innermost part. The first turn of the winding that forms the first layer includes a winding start portion and a portion extending along the second tooth side surface. The winding start portion extends, for example, along the first tooth side surface through the first innermost part. It is desirable for the portion extending along the second tooth side surface to pass through the second innermost part.

The coil is formed by the winding wound in a concentrated manner over multiple layers around the tooth and the insulator extension using, for example, a winding nozzle. The winding operation for the winding using a winding nozzle is performed while securing the winding to prevent the winding start portion from loosening at the first innermost part. Thus, the winding start portion extends through the first innermost part along the first tooth side surface.

When the portion extending along the second tooth side surface is wound around the second tooth side surface, the winding nozzle may not reach the second innermost part due to its trajectory. In such cases, the portion extending along the second tooth side surface passes through a position that is farther from the inner circumferential surface of the yoke than the second innermost part.

Thus, a dead space occurs in the second innermost part of the slot, resulting in a decrease in the space factor of the winding in the slot. The decrease in the space factor of the winding leads to a deterioration in the quality of the rotating electric machine. Accordingly, it is desired to provide a high-quality rotating electric machine in which the winding operation for the winding is relatively easy.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure provides a stator for a rotating electric machine. The stator includes a stator core including a tubular yoke and teeth extending from an inner circumferential surface of the yoke toward an inner side in a radial direction of the yoke. A slot is defined between adjacent ones of the teeth in a circumferential direction of the yoke. The stator further includes a coil formed by a winding wound around the stator core. The winding passes through the slot. The stator further includes an insulator facing a core end face and configured to insulate between the coil and the core end face. The core end face is an end face of the stator core in an axial direction of the yoke. The teeth each include a first tooth side surface located on a first side in the circumferential direction and a second tooth side surface located on a second side in the circumferential direction. The insulator includes a tubular insulator base facing the yoke in the axial direction and insulator extensions extending from an inner circumferential surface of the insulator base toward the inner side in the radial direction and respectively facing the teeth in the axial direction. The insulator extension includes an outer end face located on a side opposite to the stator core. The coil is formed by the winding wound in a concentrated manner over multiple layers around the teeth and the insulator extensions. A first layer of the coil is formed by the winding wound from an outer side toward the inner side in the radial direction. The coil includes a specific layer that is a second layer or a layer subsequent to the second layer of the coil and is formed by the winding wound from the inner side toward the outer side in the radial direction. Of a portion of each of the slots that is proximate to the inner circumferential surface of the yoke, a portion proximate to the first tooth side surface is referred to as a first innermost part and a portion proximate to the second tooth side surface is referred to as a second innermost part. A first turn of the winding that forms the first layer includes a winding start portion extending along the first tooth side surface through the first innermost part, a portion extending along the second tooth side surface through a position in the slot farther from the inner circumferential surface of the yoke than the second innermost part, and a portion wound around the outer end face of the insulator extension. The outer end face includes a protrusion protruding from a portion of the outer end face that is closer to the insulator base than the first turn and relatively close to the winding start portion. The winding that forms the specific layer is extended through the second innermost part along the second tooth side surface and then arranged on the protrusion.

Another aspect of the present disclosure provides an insulator included in a stator for a rotating electric machine. The stator includes a stator core including a tubular yoke and teeth extending from an inner circumferential surface of the yoke toward an inner side in a radial direction of the yoke. A slot is defined between adjacent ones of the teeth in a circumferential direction of the yoke. The stator further includes a coil formed by a winding wound around the stator core. The winding passes through the slot. The insulator faces a core end face and configured to insulate between the coil and the core end face. The core end face is located on an end face of the stator core in an axial direction of the yoke. The insulator includes a tubular insulator base facing the yoke in the axial direction and insulator extensions extending from an inner circumferential surface of the insulator base toward the inner side in the radial direction and respectively facing the teeth in the axial direction. The insulator extension includes an outer end face located on a side opposite to the stator core. The outer end face includes a protrusion located at an end of the outer end face on an outer side in the radial direction and located on a first side in the circumferential direction.

Other features and aspects will be apparent from the following detailed description, the drawings, and the claims.

### BRIEF DESCRIPTION OF THE DRAWINGS

FIG. 1 is a cross-sectional view showing a rotating electric machine in an embodiment.

FIG. 2 is an exploded perspective view of the stator core and the two insulators of the rotating electric machine shown in FIG. 1.

FIG. 3 is a perspective view illustrating the protrusion provided on each insulator shown in FIG. 2.

FIG. 4 is a cross-sectional view illustrating the protrusion shown in FIG. 3.

FIG. 5 is a diagram illustrating a winding operation for the winding around the stator core and the two insulators shown in FIG. 2.

FIG. 6 is a diagram illustrating a winding operation for the winding around the stator core and the two insulators shown in FIG. 2.

FIG. 7 is a diagram illustrating a winding operation for the winding around the stator core and the two insulators shown in FIG. 2.

FIG. 8 is a diagram illustrating a winding operation for the winding around the stator core and the two insulators shown in FIG. 2.

FIG. 9 is a diagram illustrating a winding operation for the winding around the stator core and the two insulators shown in FIG. 2.

FIG. 10 is a diagram illustrating a winding operation for the winding around the stator core and the two insulators shown in FIG. 2.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

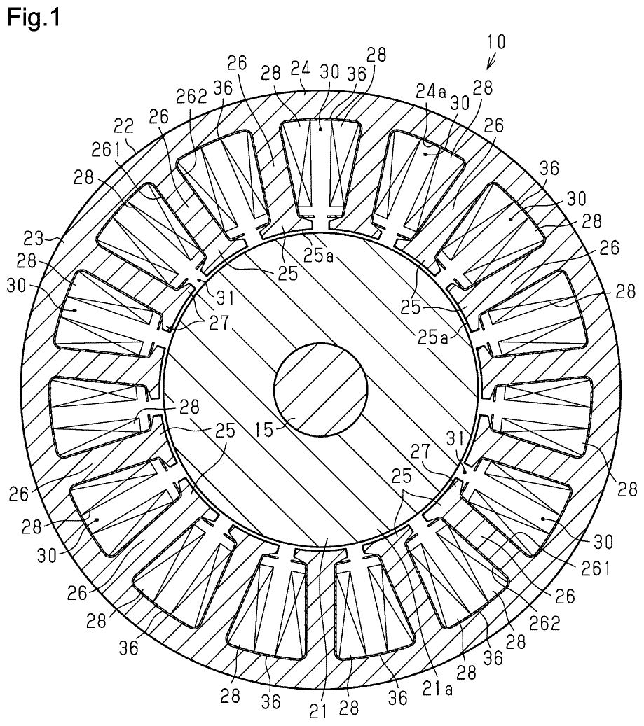

A stator for a rotating electric machine and an insulator according to an embodiment will now be described with reference to FIGS. 1 to 10.

### Overall Structure of Rotating Electric Machine

As shown in FIG. 1, the rotating electric machine 10 includes a rotor 21 and a stator 22. The stator 22 is tubular. The rotor 21 is disposed on the inner side of the stator 22. The rotor 21 includes a cylindrical rotor core 21a and permanent magnets (not shown) embedded in the rotor core 21a. The rotor core 21a is fixed to a rotary shaft 15. The rotor core 21a is configured to rotate integrally with the rotary shaft 15.

### Stator Core

The stator 22 includes a stator core 23. The stator core 23 includes a yoke 24 and teeth 25. The yoke 24 is cylindrical. The axial direction of the yoke 24 corresponds to the axial direction of the stator core 23. The circumferential direction of the yoke 24 corresponds to the circumferential direction of the stator core 23. The radial direction of the yoke 24 corresponds to the radial direction of the stator core 23. Hereinafter, the axial direction of the yoke 24 may be simply referred to as the axial direction, the radial direction of the yoke 24 may be simply referred to as the radial direction, and the circumferential direction of the yoke 24 may be simply referred to as the circumferential direction.

The teeth 25 extend toward the inner side from an inner circumferential surface 24a of the yoke 24 in the radial direction. The teeth 25 are spaced apart from each other in the circumferential direction. The teeth 25 are arranged at regular intervals in the circumferential direction. Each tooth 25 extends from the inner circumferential surface 24a of the yoke 24 toward the axis of the stator core 23. In the present embodiment, the stator core 23 includes fifteen teeth 25. While the number of the teeth 25 is not particularly limited, the number of the teeth 25 is a multiple of three.

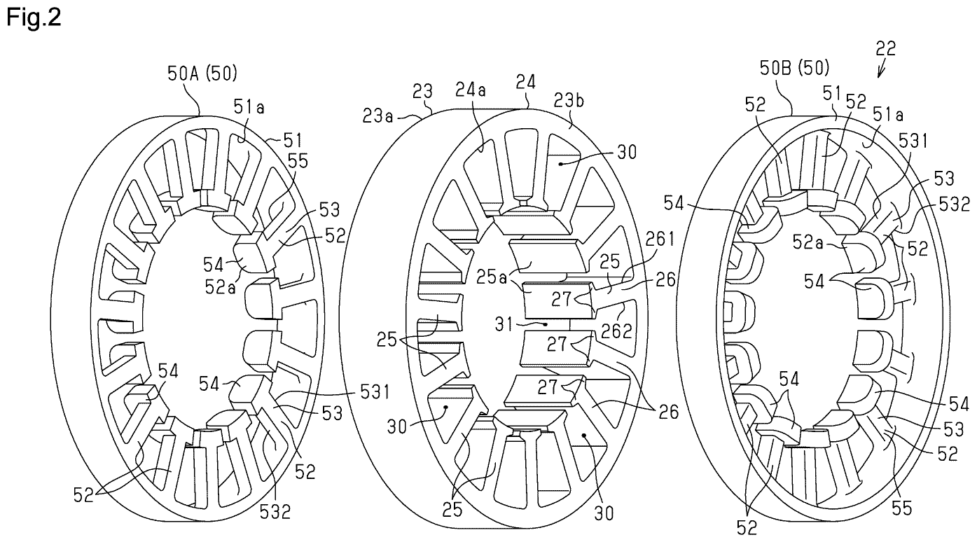

As shown in FIG. 2, the end faces of the yoke 24 respectively located on the opposite sides in the axial direction are flat. The end faces of each tooth 25 respectively located on the opposite sides in the axial direction are flat. The length of the yoke 24 in the axial direction is equal to the length of each tooth 25 in the axial direction. A first end face located on a first side of the yoke 24 in the axial direction is located on the same plane as a first end face located on a first side of each tooth 25 in the axial direction. A second end face located on a second side of the yoke 24 in the axial direction is located on the same plane as a second end face located on a second side of each tooth 25 in the axial direction.

The first end face of the yoke 24 and the first end face of each tooth 25 define a first core end face 23a, which is located on a first side in the axial direction of the stator core 23. The second end face of the yoke 24 and the second end face of each tooth 25 define a second core end face 23b, which is located on a second side in the axial direction of the stator core 23. Thus, the stator core 23 includes the first core end face 23a and the second core end face 23b.

As shown in FIGS. 1 and 2, each tooth 25 includes a tooth extension 26 and a tooth flange 27. The tooth extension 26 is a thin plate that extends from the inner circumferential surface 24a of the yoke 24. The tooth extension 26 extends in the axial direction from the first core end face 23a to the second core end face 23b of the stator core 23. Each tooth extension 26 includes a first tooth side surface 261 and a second tooth side surface 262. The first tooth side surface 261 is located on a first side of the tooth extension 26 in the circumferential direction. The second tooth side surface 262 is located on a second side of the tooth extension 26 in the circumferential direction. Thus, the teeth 25 each include the first tooth side surface 261 located on the first side in the circumferential direction and the second tooth side surface 262 located on the second side in the circumferential direction. The first tooth side surface 261 and the second tooth side surface 262 are continuous with the inner circumferential surface 24a of the yoke 24. The tooth flange 27 protrudes in the circumferential direction from the end of each of the first tooth side surface 261 and the second tooth side surface 262 on the inner side in the radial direction. Thus, the tooth flange 27 protrudes from the end of the tooth extension 26 in the radial direction toward the opposite sides in the circumferential direction.

Slots 30 are defined in the stator core 23. Each slot 30 is defined between adjacent ones of the teeth 25 in the circumferential direction. The slot 30 is a space defined by the inner circumferential surface 24a of the yoke 24, the first tooth side surface 261 and the second tooth side surface 262 facing each other in the circumferential direction, and a surface of the tooth flange 27 located on the outer side in the radial direction. Of the portion of the slot 30 that is proximate to the inner circumferential surface 24a of the yoke 24, a portion proximate to the first tooth side surface 261 may be referred to as a first innermost part 30a and a portion proximate to the second tooth side surface 262 may be referred to as a second innermost part 30b. Further, the stator core 23 includes slot openings 31. Each slot opening 31 is a gap between adjacent ones of the tooth flanges 27 in the circumferential direction. Each slot opening 31 is connected to the corresponding slot 30.

### Insulator

As shown in FIG. 2, the stator 22 includes two insulators 50. Thus, the insulators 50 are included in the stator 22. Each insulator 50 is tubular. Each insulator 50 is made of, for example, plastic.

Each insulator 50 includes an insulator base 51 and insulator tooth portions 52. The insulator base 51 is cylindrical. The insulators 50 are disposed on the stator core 23, with the axes of the insulator bases 51 coinciding with the axis of the yoke 24. Each insulator base 51 faces the yoke 24 in the axial direction. The axial direction of each insulator base 51 corresponds to the axial direction of the yoke 24. The circumferential direction of each insulator base 51 corresponds to the circumferential direction of the yoke 24. The radial direction of each insulator base 51 corresponds to the radial direction of the yoke 24.

One of the two insulators 50 may be referred to as a first insulator 50A. The other of the two insulators 50 may be referred to as a second insulator 50B. The first insulator 50A is disposed to face the first core end face 23a of the stator core 23 while being in contact with the first core end face 23a. The second insulator 50B is disposed to face the second core end face 23b of the stator core 23 while being in contact with the second core end face 23b. Thus, the insulators 50 are disposed to face a core end face, which is the end face of the stator core 23 in the axial direction. The outer diameter of the insulator base 51 is smaller than the outer diameter of the yoke 24. The inner diameter of the insulator base 51 is equal to the inner diameter of the yoke 24.

The insulator tooth portions 52 extend toward the inner side in the radial direction from an inner circumferential surface 51a of the insulator base 51. The insulator tooth portions 52 are spaced apart from each other in the circumferential direction. The insulator tooth portions 52 are arranged at equal intervals in the circumferential direction. Each insulator tooth portion 52 extends from the inner circumferential surface 51a of the insulator base 51 toward the axis of the insulator base 51. In the present embodiment, each insulator 50 includes fifteen insulator tooth portions 52. The number of the insulator tooth portions 52 is the same as the number of the teeth 25 of the stator core 23.

Each insulator tooth portion 52 includes an insulator extension 53. Thus, each insulator 50 includes multiple insulator extensions 53. Each insulator extension 53 is columnar and extends from the inner circumferential surface 51a of the insulator base 51 toward the inner side in the radial direction. The width of each insulator extension 53 in the circumferential direction is equal to the width of the corresponding tooth extension 26 in the circumferential direction. Each insulator extension 53 is in contact with the corresponding tooth 25. Each insulator extension 53 is located at a position that overlaps the corresponding tooth extension 26 in the axial direction. Thus, each insulator extension 53 faces the corresponding tooth 25 in the axial direction.

The insulator extension 53 includes a first insulator side surface 531 and a second insulator side surface 532. The first insulator side surface 531 is located on a first side of the insulator extension 53 in the circumferential direction. The first insulator side surface 531 is continuous with the first tooth side surface 261. The second insulator side surface 532 is located on a second side of the insulator extension 53 in the circumferential direction. The second insulator side surface 532 is continuous with the second tooth side surface 262.

Each insulator tooth portion 52 includes an insulator inner wall 54. Thus, each insulator 50 includes multiple insulator inner walls 54. Each insulator inner wall 54 extends from the end of the corresponding insulator extension 53 on the inner side in the radial direction and protrudes along the insulator base 51. Each insulator inner wall 54 protrudes from the corresponding insulator extension 53 toward the opposite sides in the circumferential direction and protrude toward a side opposite to the stator core 23 in the axial direction. In this manner, each insulator inner wall 54 protrudes from the corresponding insulator extension 53. Each insulator inner wall 54 is located at a position overlapping the corresponding tooth flange 27 in the axial direction. Thus, each insulator inner wall 54 faces the corresponding tooth flange 27 in the axial direction.

Each insulator tooth portion 52 includes a surface 52a located on the inner side in the radial direction, and the corresponding tooth 25 includes a surface 25a located on the inner side in the radial direction. The surfaces 52a and the surfaces 25a are located on the same plane. The surface of each insulator inner wall 54 located on the inner side in the radial direction defines the surface 52a of the corresponding insulator tooth portion 52 located on the inner side in the radial direction. The surface of each tooth flange 27 located on the inner side in the radial direction defines the surface 25a of the corresponding tooth 25 located on the inner side in the radial direction. The thickness of each insulator inner wall 54 is greater than the thickness of the corresponding tooth flange 27.

Each insulator extension 53 includes an outer end face 55 located on a side opposite to the stator core 23. The outer end face 55 is flat. The outer end face 55 is continuous with the inner circumferential surface 51a of the insulator base 51. The outer end face 55 is continuous with the surface of the insulator inner wall 54 located on the outer side in the radial direction. The outer end face 55 connects the inner circumferential surface 51a of the insulator base 51 and the surface of the insulator inner wall 54 located on the outer side in the radial direction with each other.

### Coil

As shown in FIG. 1, the stator 22 includes coils 28. The stator 22 includes U-phase, V-phase, and W-phase coils 28. Thus, the stator 22 include multi-phase coils 28. A portion of each coil 28 extends through the corresponding slot 30. Another portion of the coil 28 protrudes from the first core end face 23a and the second core end face 23b. The first insulator 50A insulates between the coil 28 and the first core end face 23a. The second insulator 50B insulates between the coil 28 and the second core end face 23b. The portion of the coil 28 that passes through the slot 30 is insulated from the stator core 23 by a slot insulating paper 36.

### Protrusion

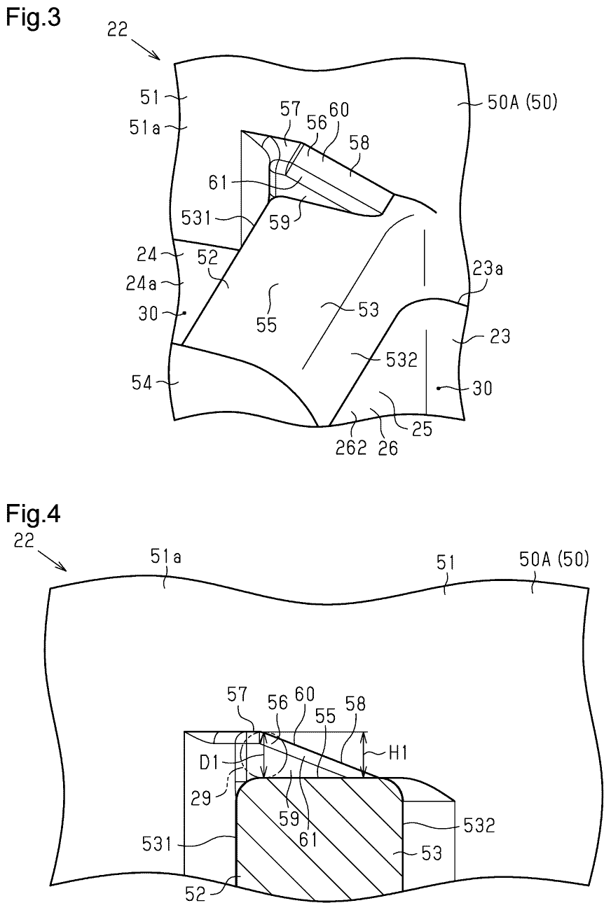

As shown in FIGS. 3 and 4, the outer end face 55 of each insulator extension 53 of the first insulator 50A includes a protrusion 56. The protrusion 56 is located at the end of the outer end face 55 on the outer side in the radial direction. The protrusion 56 includes a top 57, an inclined surface 58, and a protrusion side surface 59. The top 57 is flat. The top 57 extends parallel to the outer end face 55.

As shown in FIG. 4, a protrusion height H1, which is the height from the outer end face 55 to the top 57 of the protrusion 56, is equal to an outer diameter D1 of a winding 29 that forms the coil 28. As shown in FIGS. 3 and 4, the top 57 of the protrusion 56 is located at the end of the outer end face 55 on the outer side in the radial direction and is located relatively close to the first insulator side surface 531. Thus, the outer end face 55 includes the protrusion 56, which is located at the end of the outer end face 55 on the outer side in the radial direction and is located on a first side in the circumferential direction.

The inclined surface 58 is flat. The inclined surface 58 extends diagonally from the outer end face 55. The inclined surface 58 is continuous with the top 57 of the protrusion 56. The end of the inclined surface 58 located on a side opposite to the top 57 is continuous with the outer end face 55. The protrusion height of the inclined surface 58 from the outer end face 55 gradually increases from a portion of the outer end face 55 relatively close to the second insulator side surface 532 toward the top 57. Thus, the inclined surface 58 is continuous with the top 57 of the protrusion 56, and the protrusion height of the inclined surface 58 from the outer end face 55 gradually increases from a second side of the outer end face 55 in the circumferential direction toward the top 57.

The protrusion side surface 59 is a side surface of the protrusion 56 located on a side opposite to the insulator base 51. That is, the protrusion side surface 59 is a side surface of the protrusion 56 located on the inner side in the radial direction. The protrusion side surface 59 is flat. The protrusion side surface 59 extends upright from the outer end face 55. The protrusion side surface 59 extends in a direction that is orthogonal to the outer end face 55 and orthogonal to the radial direction.

The protrusion 56 includes a protrusion end face 60 located at the tip in the protruding direction from the outer end face 55. The protrusion end face 60 includes the top 57 and the inclined surface 58. The edge of the top 57 located on the inner side in the radial direction is continuous with the edge of the inclined surface 58 located on the inner side in the radial direction. The edge of the top 57 located on the inner side in the radial direction and the edge of the inclined surface 58 located on the inner side in the radial direction define an edge 61 of the protrusion end face 60 located on the inner side in the radial direction. The edge of the top 57 located on the inner side in the radial direction is chamfered in an arcuate shape. The edge of the inclined surface 58 located on the inner side in the radial direction is chamfered in an arcuate shape. Thus, the edge 61 of the protrusion end face 60 located on the inner side in the radial direction, that is, located on a side opposite to the insulator base 51, is chamfered in an arcuate shape.

### Winding

The structure of each coil 28 will now be described in addition to a winding operation for the winding 29.

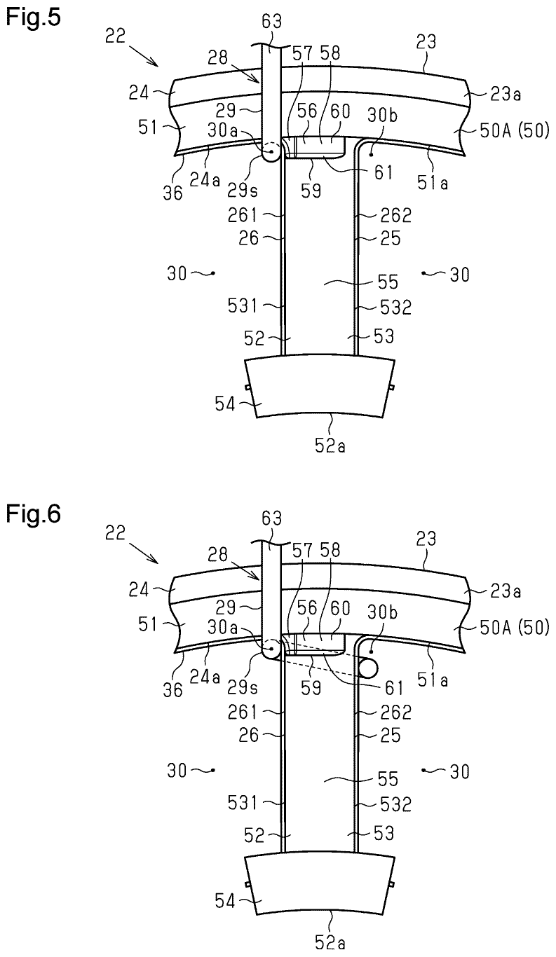

As shown in FIG. 5, the coil 28 is formed by the winding 29 passing through the slot 30 around the stator core 23. The coil 28 is formed by the winding 29 wound in a concentrated manner over multiple layers around the tooth 25 and the insulator extension 53, with the winding 29 moving back and forth in the radial direction of the yoke 24. The coil 28 is formed by the winding 29 wound over, for example, four layers. The winding 29 extends helically in each layer of the coil 28. The winding operation for the winding 29 is performed using, for example, a winding nozzle (not shown).

As shown in FIGS. 5, 6, 7, 8, 9, and 10, the first layer of the coil 28 may be formed by the winding 29 wound from the outer side toward the inner side of the yoke 24 in the radial direction. The second layer of the coil 28 is formed by the winding 29 wound from the inner side toward the outer side of the yoke 24 in the radial direction. The third layer of the coil 28 is formed by the winding 29 wound from the outer side toward the inner side of the yoke 24 in the radial direction. The fourth layer of the coil 28 is formed by the winding 29 wound from the inner side toward the outer side of the yoke 24 in the radial direction. Thus, each of the second and fourth layers of the coil 28 is a specific layer 62 that is formed by the winding 29 wound from the inner side toward the outer side of the yoke 24 in the radial direction. Accordingly, the coil 28 includes the specific layer 62, which is the second layer or a layer subsequent to the second layer of the coil 28 and is formed by the winding 29 wound from the inner side toward the outer side of the yoke 24 in the radial direction. In FIGS. 5, 6, 7, 8, 9, and 10, the third and fourth layers of the coil 28 are not shown.

As shown in FIG. 5, the winding 29 includes a lead 63. The lead 63 is drawn toward the outer side in the radial direction over the end face of the insulator base 51 of the first insulator 50A. The winding 29 further includes a winding start portion 29s that forms the first layer of the coil 28. The winding start portion 29s is continuous with the lead 63. The winding start portion 29s is inserted into the slot 30 through the first insulator 50A. The winding start portion 29s extends through the first innermost part 30a within the slot 30 along the first tooth side surface 261. The winding operation for the winding 29 using a winding nozzle is performed while securing the winding 29 at the winding start portion 29s to prevent it from loosening at the first innermost part 30a.

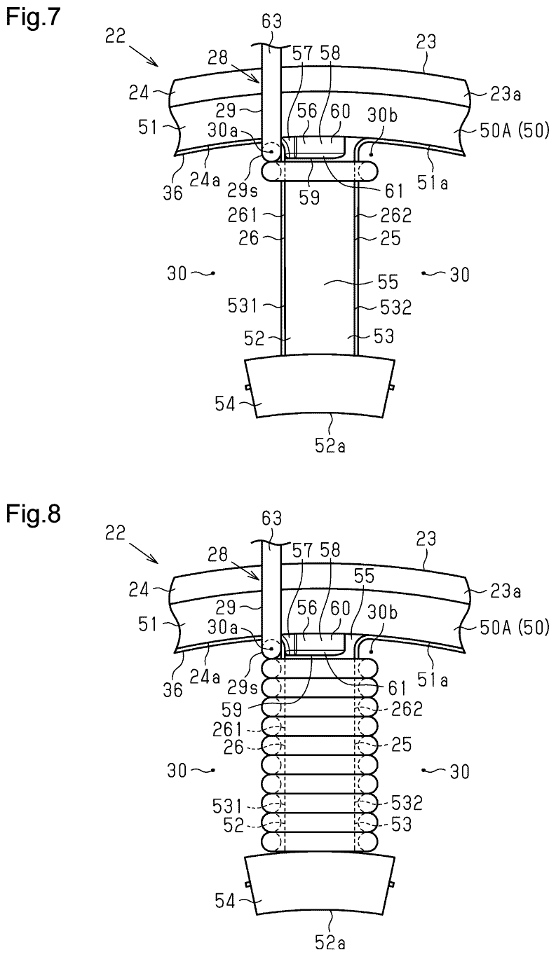

As illustrated in FIGS. 6 and 7, in addition to the above-described winding start portion 29s, the first turn of the winding 29 that forms the first layer of the coil 28 includes a first section, a second section, and a third section. The first section is wound around the outer end face 55 of the insulator extension 53 of the second insulator 50B. The second section extends along the second tooth side surface 262. The third section is wound around the outer end face 55 of the insulator extension 53 of the first insulator 50A.

In FIG. 6, the first section of the first turn of the winding 29 is indicated by a broken line. As shown in FIG. 6, the first section of the first turn of the winding 29 extends toward the inner side in the radial direction from the first insulator side surface 531 toward the second insulator side surface 532. The second section of the first turn of the winding 29 is located at a position in the slot 30 farther from the inner circumferential surface 24a of the yoke 24 than the second innermost part 30b.

When the second section of the first turn of the winding 29 is wound around the second tooth side surface 262, the winding nozzle does not reach the second innermost part 30b due to its trajectory. Thus, the second section of the first turn of the winding 29 is located farther from the inner circumferential surface 24a of the yoke 24 than the second innermost part 30b.

As shown in FIG. 7, the third section of the first turn of the winding 29 corresponds to a section preceding the second turn of the winding 29. The third section of the first turn of the winding 29 extends in a direction that is orthogonal to the radial direction. The third section of the first turn of the winding 29 extends along the protrusion side surface 59 of the protrusion 56. The start portion of the second turn of the winding 29 that forms the first layer of the coil 28 extends along the first tooth side surface 261, aligned with the winding start portion 29s on the inner side in the radial direction.

As shown in FIG. 8, in the same manner as the first turn, the winding 29 is helically wound from the outer side toward the inner side of the yoke 24 in the radial direction for the second and subsequent turns. This forms the first layer of the coil 28.

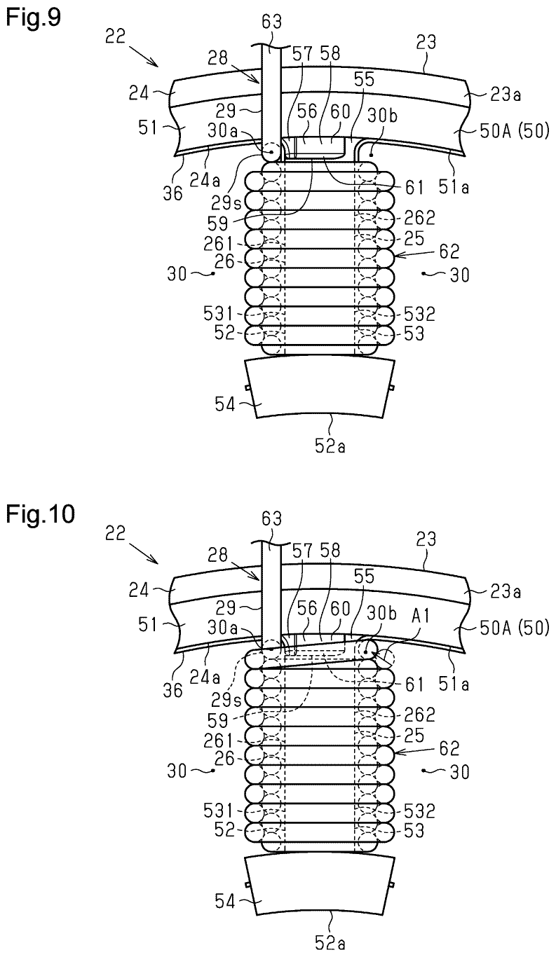

As shown in FIG. 9, the second layer of the coil 28 is wound around the outer circumference of the first layer of the coil 28. The second layer of the coil 28 is formed by the winding 29 wound in a helical pattern around the first layer from the inner side toward the outer side of the yoke 24 in the radial direction.

As shown in FIG. 10, the winding 29 that forms the second layer is wound from the inner side toward the outer side of the yoke 24 in the radial direction. When the second layer of the winding 29 is wound around the second tooth side surface 262, the first layer of the winding 29, which has already been wound around the second tooth side surface 262, guides part of the second layer of the winding 29, indicated by the long dashed double-short dashed line in FIG. 10, to the second innermost part 30b, as shown by arrow A1. As a result, the winding 29 that forms the second layer is located at the second innermost part 30b. Further, the winding 29 that forms the second layer is extended through the second innermost part 30b along the second tooth side surface 262 and then arranged on the protrusion 56. As a result, the winding 29 that forms the second layer is guided by the protrusion 56 to be located farther from the first tooth side surface 261 than the winding 29 that forms the first layer. The winding 29 arranged on the protrusion 56 extends along the inclined surface 58. Thus, the winding 29 arranged on the protrusion 56 gradually becomes farther from the outer end face 55, from a portion of the outer end face 55 opposite to the winding start portion 29s toward the top 57.

In this manner, the first turn of the winding 29 is wound around the outer end face 55 of the insulator extension 53 of the first insulator 50A. The outer end face 55 of the insulator extension 53 of the first insulator 50A includes the protrusion 56 protruding from a portion of the outer end face 55 that is closer to the insulator base 51 than the first turn of the winding 29 and relatively close to the winding start portion 29s. In other words, the outer end face 55 of the insulator extension 53 of the first insulator 50A includes the protrusion 56 protruding from a portion of the outer end face 55 that is closer to the insulator base 51 than the first turn of the winding 29 and proximate to the winding start portion 29s. Further, the winding 29 that forms the second layer is extended through the second innermost part 30b along the second tooth side surface 262 and then arranged on the protrusion 56. Thus, the winding 29 that forms the specific layer 62 is extended through the second innermost part 30b along the second tooth side surface 262 and then arranged on the protrusion 56. In the present embodiment, the winding 29 that forms the specific layer 62 and extends through the second innermost part 30b along the second tooth side surface 262 is the winding 29 that forms the second layer.

The protrusion 56 guides the winding 29 that has been extended through the second innermost part 30b along the second tooth side surface 262 such that the winding 29 that has been extended through the second innermost part 30b along the second tooth side surface 262 is wound around the winding 29 that forms the first layer. Subsequently, for the third and fourth layers, in the same manner as the first and second layers, the coil 28 is formed by the winding 29 wound in a concentrated manner around the tooth 25 and the insulator extension 53, with the winding 29 moving back and forth in the radial direction of the yoke 24. Thus, the coil 28 is formed by the winding 29 wound in a concentrated manner over multiple layers around the tooth 25 and insulator extensions 53, with the winding 29 moving back and forth in the radial direction of the yoke 24. As a result of the above-described winding operation for the winding 29, the coil 28 is formed.

### Operation of Embodiment

The operation of the present embodiment will now be described.

When the third section of the first turn of the winding 29 wound around the outer end face 55 comes into contact with the protrusion 56, the winding 29 that forms the first layer is prevented from shifting toward the outer side of the yoke 24 in the radial direction. This stabilizes the winding 29 of the first layer, resulting in improved alignment of the winding 29. The winding 29 that forms the second layer is extended through the second innermost part 30b along the second tooth side surface 262 and then arranged on the protrusion 56. Further, the winding 29 that forms the second layer is guided by the protrusion 56 to be located farther from the first tooth side surface 261 than the winding 29 that forms the first layer. Accordingly, even if the winding 29 that forms the second layer is extended through the second innermost part 30b along the second tooth side surface 262, the winding operation for its subsequent layers of the winding 29 is performed smoothly.

### Advantages of Embodiment

The above embodiment provides the following advantages.

(1) The winding 29 that forms the second layer is wound from the inner side toward the outer side in the radial direction. When the second layer of the winding 29 is wound around the second tooth side surface 262, the winding 29 that has already been wound around the second tooth side surface 262 guides part of the second layer of the winding 29 to the second innermost part 30b. As a result, the winding 29 that forms the second layer is located at the second innermost part 30b. Thus, since the winding 29 extends through the second innermost part 30b along the second tooth side surface 262, no dead space occurs in the second innermost part 30b within the slot 30. This improves the space factor of the winding 29 in the slot 30. Further, for example, the second section of the first turn of the winding 29 extending along the second tooth side surface 262 does not need to be forcibly pushed onto the second innermost part 30b such that the winding 29 extends through the second innermost part 30b along the second tooth side surface 262. This allows for maintaining the alignment of the winding 29 during the winding process, resulting in a high-quality winding 29. Furthermore, when the third section wound around the outer end face 55 in the first turn of the winding 29 comes into contact with the protrusion 56, the winding 29 that forms the first layer is prevented from shifting toward the outer side of the yoke 24 in the radial direction. Since the first layer of the winding 29 is stable, this allows for maintaining the alignment of the winding 29 during the winding process, resulting in a high-quality winding 29. Additionally, the winding 29 that forms the second layer is extended through the second innermost part 30b along the second tooth side surface 262 and then arranged on the protrusion 56, and the winding 29 that forms the second layer is guided by the protrusion 56 to be located farther from the first tooth side surface 261 than the winding 29 that forms the first layer. In this configuration, even if the winding 29 that forms the second layer is extended through the second innermost part 30b along the second tooth side surface 262, the winding operation for its subsequent layers of the winding 29 is performed smoothly. Hence, a high-quality rotating electric machine 10 in which the winding operation for the winding 29 is relatively easy is provided. In addition, the improvement of the space factor reduces the size of the rotating electric machine 10 and enhances its output.

(2) The protrusion height H1 of the top 57 of the protrusion 56 from the outer end face 55 is equal to the outer diameter D1 of the winding 29. Thus, the winding 29 that has been extended through the second innermost part 30b along the second tooth side surface 262 is easily aligned with the position of the winding 29 that forms the second layer. This facilitates the guiding of the winding 29 by the protrusion 56 such that the winding 29 that has been extended through the second innermost part 30b along the second tooth side surface 262 is wound around the winding 29 that forms the first layer. This further facilitates the winding operation for the winding 29.

(3) The winding 29 that forms the specific layer 62 and extends through the second innermost part 30b along the second tooth side surface 262 is the winding 29 that forms the second layer. In this configuration, for example, compared with when the winding 29 extending through the second innermost part 30b along the second tooth side surface 262 is the winding 29 that forms the fourth layer, the alignment of the winding 29 is improved. This provides a higher-quality rotating electric machine 10.

(4) The protrusion 56 includes the inclined surface 58, which is continuous with the top 57 of the protrusion 56. The protrusion height of the inclined surface 58 from the outer end face 55 gradually increases from the portion of the outer end face 55 opposite to the winding start portion 29s toward the top 57. This allows the winding 29 arranged on the protrusion 56 to extend along the inclined surface 58. Thus, the winding 29 is prevented from bending locally, thereby avoiding damage to the durability of the winding 29. This provides a higher-quality rotating electric machine 10.

(5) The edge 61 of the protrusion end face 60 located on the side opposite to the insulator base 51 is chamfered in an arcuate shape. In this configuration, even if the winding 29 on the protrusion 56 is pressed against the edge 61, the load applied to the winding 29 is reduced, thereby avoiding damage to the durability of the winding 29. This provides a higher-quality rotating electric machine 10.

(6) The outer end face 55 includes the protrusion 56, which is located at the end of the outer end face 55 on the outer side in the radial direction and is located on the first side in the circumferential direction. This configuration provides a high-quality rotating electric machine 10 in which the winding operation for the winding 29 is relatively easy.

### Modifications

The above embodiments may be modified as follows. The above-described embodiment and the following modifications can be combined if the combined modifications remain technically consistent with each other.

In the embodiment, the protrusion height H1 of the top 57 of the protrusion 56 from the outer end face 55 may be greater than or less than the outer diameter D1 of the winding 29.

In the embodiment, the winding 29 extending through the second innermost part 30b along the second tooth side surface 262 may be, for example, the winding 29 that forms the fourth layer. In short, the winding 29 that extends through the second innermost part 30b along the second tooth side surface 262 simply needs to be the winding 29 that forms the specific layer 62.

In the embodiment, the winding 29 extending through the second innermost part 30b along the second tooth side surface 262 may be, for example, the winding 29 that forms the fourth layer. Further, the winding 29 may be guided by the protrusion 56 such that, for example, the winding 29 that has been extended through the second innermost part 30b along the second tooth side surface 262 is wound around the winding 29 that forms the third layer. In such a case, the protrusion height H1 of the top 57 of the protrusion 56 from the outer end face 55 should be three times the outer diameter D1 of the winding 29.

In the embodiment, the protrusion 56 does not need to include the inclined surface 58. The protrusion 56 simply needs to protrude from a portion of the outer end face 55 closer to the insulator base 51 than the first turn of the winding 29 that forms the first layer and relatively close to the winding start portion 29s. In other words, the protrusion 56 simply needs to be located at the end of the outer end face 55 on the outer side in the radial direction and located on the first side in the circumferential direction.

In the embodiment, the edge 61 does not need to be chamfered in an arcuate shape.

In the embodiment, the number of layers of the winding 29 that forms the coil 28 is not particularly limited.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A stator for a rotating electric machine, the stator comprising:
a stator core including a tubular yoke and teeth extending from an inner circumferential surface of the yoke toward an inner side in a radial direction of the yoke, wherein a slot is defined between adjacent ones of the teeth in a circumferential direction of the yoke;
a coil formed by a winding wound around the stator core, the winding passing through the slot; and
an insulator facing a core end face and configured to insulate between the coil and the core end face, the core end face being an end face of the stator core in an axial direction of the yoke, wherein
the teeth each include a first tooth side surface located on a first side in the circumferential direction and a second tooth side surface located on a second side in the circumferential direction,
the insulator includes:
a tubular insulator base facing the yoke in the axial direction; and
insulator extensions extending from an inner circumferential surface of the insulator base toward the inner side in the radial direction and respectively facing the teeth in the axial direction,
the insulator extension includes an outer end face located on a side opposite to the stator core,
the coil is formed by the winding wound in a concentrated manner over multiple layers around the teeth and the insulator extensions,
a first layer of the coil is formed by the winding wound from an outer side toward the inner side in the radial direction,
the coil includes a specific layer that is a second layer or a layer subsequent to the second layer of the coil and is formed by the winding wound from the inner side toward the outer side in the radial direction,
of a portion of each of the slots that is proximate to the inner circumferential surface of the yoke, a portion proximate to the first tooth side surface is referred to as a first innermost part and a portion proximate to the second tooth side surface is referred to as a second innermost part,
a first turn of the winding that forms the first layer includes:
a winding start portion extending along the first tooth side surface through the first innermost part;
a portion extending along the second tooth side surface through a position in the slot farther from the inner circumferential surface of the yoke than the second innermost part; and
a portion wound around the outer end face of the insulator extension,
the outer end face includes a protrusion protruding from a portion of the outer end face that is closer to the insulator base than the first turn and relatively close to the winding start portion, and
the winding that forms the specific layer is extended through the second innermost part along the second tooth side surface and then arranged on the protrusion.

2. The stator for the rotating electric machine according to claim 1, wherein
a protrusion height of a top of the protrusion from the outer end face is equal to an outer diameter of the winding, and
the protrusion is configured to guide the winding that has been extended through the second innermost part along the second tooth side surface such that the winding that has been extended through the second innermost part along the second tooth side surface is wound around the winding that forms the first layer.

3. The stator for the rotating electric machine according to claim 1, wherein
the winding that extends through the second innermost part along the second tooth side surface is the winding that forms the second layer.

4. The stator for the rotating electric machine according to claim 1, wherein
the protrusion includes an inclined surface continuous with a top of the protrusion, wherein a protrusion height of the inclined surface from the outer end face gradually increases from a portion of the outer end face opposite to the winding start portion toward the top.

5. The stator for the rotating electric machine according to claim 1, wherein
the protrusion includes a protrusion end face located at a tip in a protruding direction from the outer end face, and
an edge of the protrusion end face located on a side opposite to the insulator base is chamfered in an arcuate shape.

6. An insulator included in a stator for a rotating electric machine, wherein
the stator includes:
a stator core including a tubular yoke and teeth extending from an inner circumferential surface of the yoke toward an inner side in a radial direction of the yoke, wherein a slot is defined between adjacent ones of the teeth in a circumferential direction of the yoke; and
a coil formed by a winding wound around the stator core, the winding passing through the slot,
the insulator faces a core end face and configured to insulate between the coil and the core end face, the core end face being located on an end face of the stator core in an axial direction of the yoke,
the insulator includes:
a tubular insulator base facing the yoke in the axial direction; and
insulator extensions extending from an inner circumferential surface of the insulator base toward the inner side in the radial direction and respectively facing the teeth in the axial direction,
the insulator extension includes an outer end face located on a side opposite to the stator core, and
the outer end face includes a protrusion located at an end of the outer end face on an outer side in the radial direction and located on a first side in the circumferential direction.

7. The insulator according to claim 6, wherein
the protrusion includes an inclined surface continuous with a top of the protrusion, wherein a protrusion height of the inclined surface from the outer end face gradually increases from a second side of the outer end face in the circumferential direction toward the top.

8. The insulator according to claim 6, wherein
the protrusion includes a protrusion end face located at a tip in a protruding direction from the outer end face, and
an edge of the protrusion end face located on a side opposite to the insulator base is chamfered in an arcuate shape.
